(19) United States
(12) Patent Application Publication
(10) Pub. No.: US 2026/0278064 A1
(43) Pub. Date: Sep. 17, 2026

(54) SYSTEMS AND METHODS FOR CUSTOMER-REVOKABLE ROOT OF TRUST

(71) Applicant: ServiceNow, Inc., Santa Clara, CA (US)

(72) Inventors: Huiqing Wen, San Diego, CA (US); James Adam Oravec, Las Vegas, NV (US); Roopashree Honnashettyhalli Shivanna Gowda, San Diego, CA (US); Pierre Francois Rohel, San Francisco, CA (US); Marvin Torio, San Diego, CA (US); Shantanu Sardesai, Sammamish, WA (US)

(21) Appl. No.: 19/077,344

(22) Filed: Mar. 12, 2025

(51) Int. Cl. G06F 21/44

(52) U.S. Cl. CPC G06F 21/44

(57) ABSTRACT

A method includes accessing software code, wherein the software code is signed with a first signature based on a first code signing certificate, generating a second signature for the software code using a second code signing certificate, wherein the second signature for the software code supersedes the first signature, and in response to verifying the second signature, executing the software code.

### TECHNICAL FIELD

The present disclosure relates generally to roots of trust for signed software code.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Code signing is a process of digitally signing software code to establish a root of trust and to verify the software code’s authenticity and integrity (e.g. that the code has not been modified since it was signed). When code signing is being used, the signature associated with the software code is verified prior to execution of the code. Software code provided to a customer by a software provider includes provider signatures generated by the software provider using a software provider code signing certificate. Some customers may wish to have a customer-revokable root of trust that enables the customer to unilaterally revoke (e.g., without any action taken by the software provider) the root of trust and cease execution of all signed software code. However, because the software code provided by the software provider is signed with provider signatures generated by the software provider using the software provider code signing certificate, the root of trust for the software code provided by the software provider is controlled by the software provider and thus not unilaterally revokable by the customer. Accordingly, a unified root of trust for the entirety of the software code (e.g., the software code provided by the software provider and the customizations generated by the customer) that is unilaterally revokable by the customer is needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes accessing software code, wherein the software code is signed with a first signature based on a first code signing certificate, generating a second signature for the software code using a second code signing certificate, wherein the second signature for the software code supersedes the first signature, and in response to verifying the second signature, executing the software code.

In another embodiment, a system includes processing circuitry and a memory. The memory is accessible by the processing circuitry, and stores instructions that, when executed by the processing circuitry, cause the processing circuitry to execute a client instance. The client instance is configured to access software code signed with a first signature based on a first code signing certificate, generate a second signature for the software code using a second code signing certificate, in which the second signature for the software code supersedes the first signature, and in response to verifying the second signature, execute the software code.

In a further embodiment, a non-transitory, computer readable medium comprising instructions that, when executed by processing circuitry, cause the processing circuitry to access software code signed with a first signature based on a first code signing certificate, generate a second signature for the software code using a second code signing certificate, in which the second signature for the software code supersedes the first signature, and in response to verifying the second signature, execute the software code.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIGS. 1 or 2, in accordance with aspects of the present disclosure;

FIG. 4 is a block diagram illustrating a virtual server that supports and enables a client instance that hosts signature generation and verification tools, in accordance with aspects of the present disclosure;

FIG. 5 is a flow chart of a process for creating a unified, unilaterally revokable root of trust for an enterprise’s software code, in accordance with aspects of the present disclosure;

FIG. 6 is a schematic illustrating using two cloud-based computational instances to create the unified, unilaterally revokable customer root of trust for software code of FIG. 5, in which the software code is executed by a MID server, in accordance with aspects of the present disclosure; and

FIG. 7 is a flow chart of a process for using the two cloud-based computational instances of FIG. 6 to create the unified, unilaterally revokable customer root of trust for the software code executed by the MID server of FIG. 6, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”,” real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

Code signing is a process of digitally signing software code to establish a root of trust and verify the software code’s authenticity and integrity (e.g. that the code has not been modified since it was signed). When code signing is being used, the signature associated with the software code is verified prior to execution of the code. Software code provided to a customer by a software provider includes provider signatures generated by the software provider using a software provider code signing certificate. Some customers may wish to have a customer-revokable root of trust that enables the customer to unilaterally revoke (e.g., without any action taken by the software provider) the root of trust and cease execution of all signed software code. However, because the software code provided by the software provider is signed with provider signatures generated by the software provider using the software provider code signing certificate, the root of trust for the software code provided by the software provider is controlled by the software provider and thus not unilaterally revokable by the customer. Accordingly, a unified root of trust for the entirety of the software code (e.g., the software code provided by the software provider and the customizations generated by the customer) that is unilaterally revokable by the customer is needed.

Various embodiments disclosed herein are directed to generating a customer-revokable root of trust for software code. A customer receives software code from a software provider that is signed with a signature generated by the software provider using a software provider code signing certificate. Specifically, the software provider uses the software provider code signing certificate and a signing tool to create a cryptographic signature for the software code using the software provider’s private key. The customer uses a public key to verify the signature prior to execution of the software code. If the customer makes any customizations to the software code, the customer uses a customer signing certificate to generate a customer signature for the customizations. To unify the root of trust for the entirety of the software code (e.g., the software code provided by the software provider and the customizations generated by the customer), the customer uses the customer signing certificate to generate new customer signatures for the software code provided by the software provider that supersede the provider signatures generated by the software provider. In some embodiments, the customer may use a customer instance to generate the new signatures, which may include an instance dedicated to generating signatures or the customer’s primary instance. In other embodiments, the customer may use a signature generation tool running on the customer infrastructure (e.g., “on prem”) to generate signatures and import the signatures to the customer’s instance. The customer then designates the signatures from the software provider as untrusted. With a unified root of trust for the entirety of the software code, the customer may unilaterally revoke the root of trust based on the customer signing certificate at will to prevent execution of signed code. Accordingly, use of the disclosed techniques enables the customer to unilaterally prevent execution of code without any action by or on behalf of the software provider. As such, if a vulnerability or other issue is discovered, the customer may be able to cease execution of code quickly without relying on the software provider taking any action, increasing the speed at which the customer can address the vulnerability or issue and reducing the amount of time that the network may be exposed to the vulnerability.

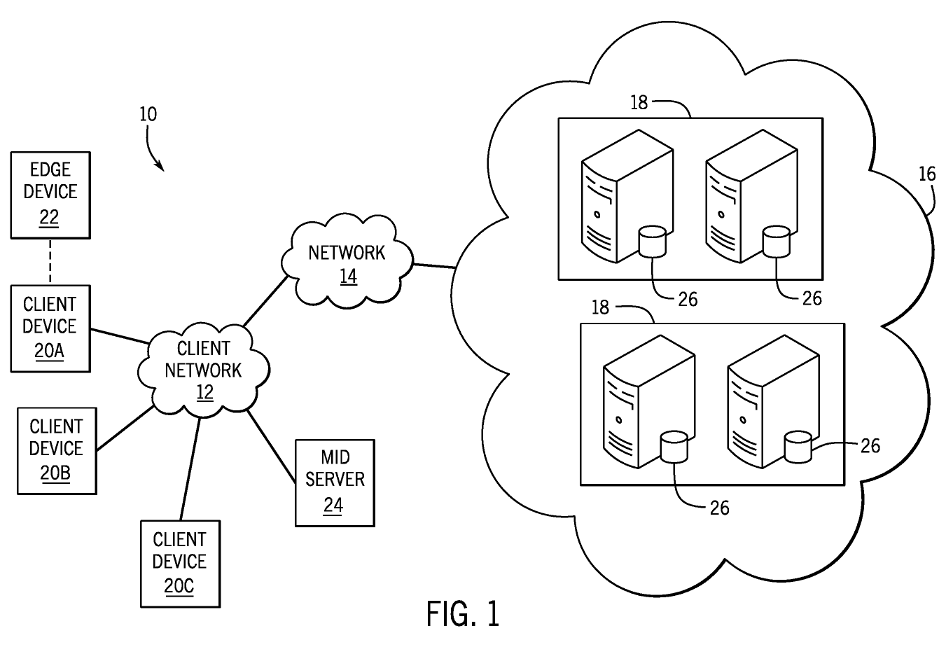

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

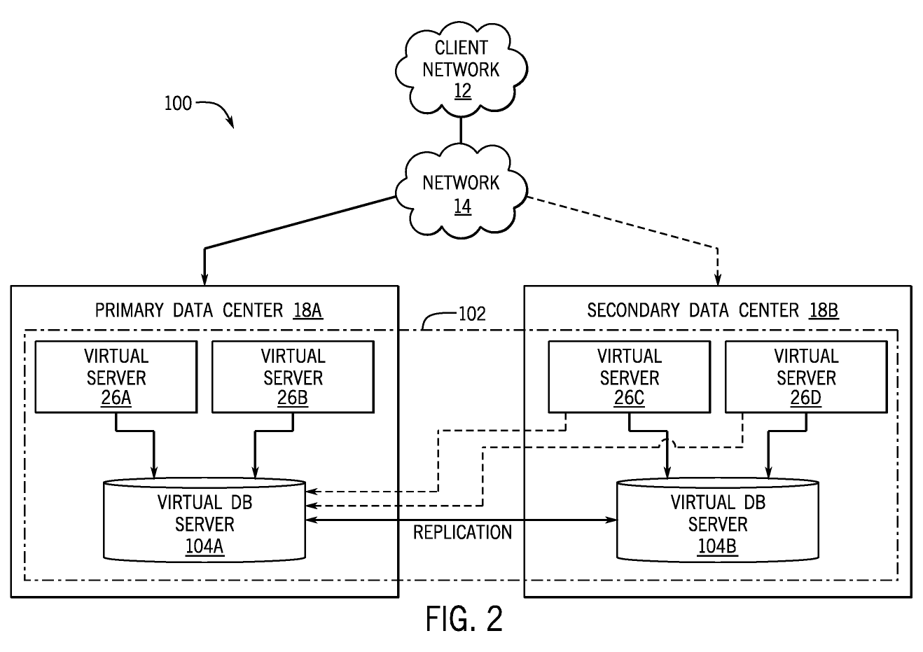

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

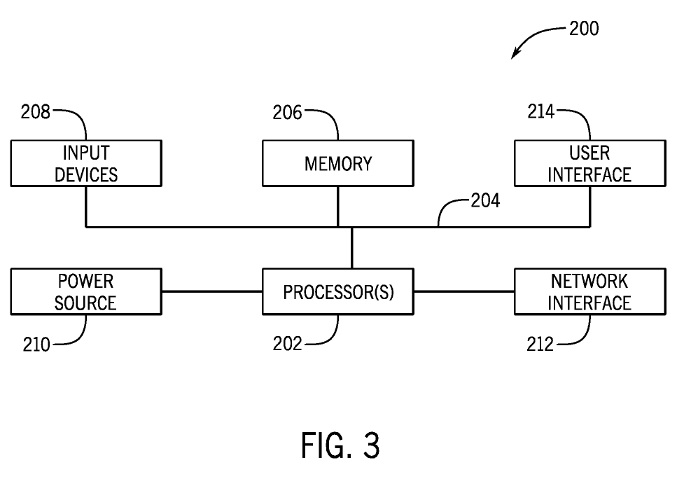

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

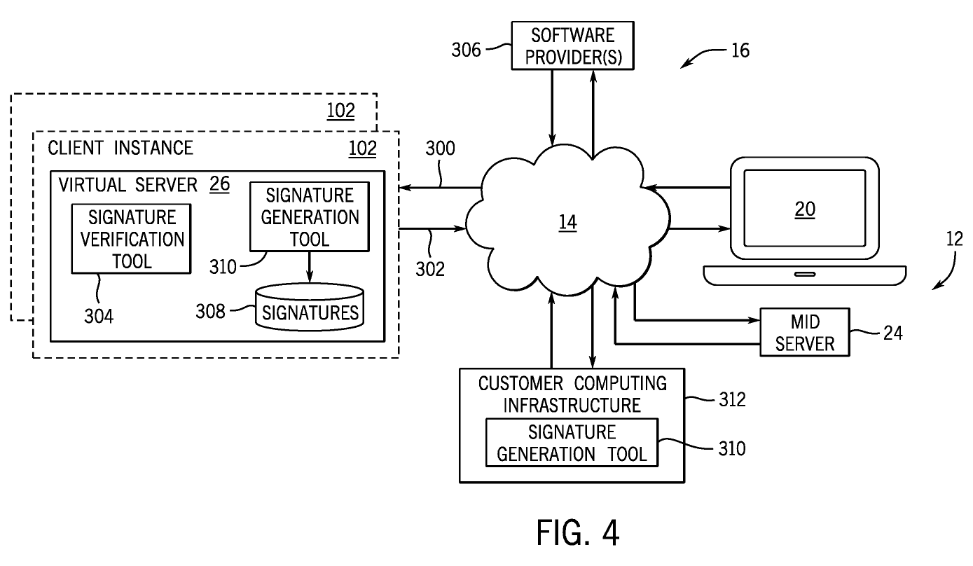

With the preceding in mind, FIG. 4 is a block diagram illustrating an embodiment in which one or more a virtual servers 26 support and enable one or more respective client instances 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser, a native application running on the client device 20, etc.). The client instance 102 is supported by one or more virtual servers 26 similar to those explained with respect to FIG. 2, and is illustrated here to show support for the disclosed functionality described herein within the client instances 102. Cloud provider infrastructures are generally configured to support a plurality of end-user devices, such as client device(s) 20, MID servers 24, and so forth, concurrently, wherein each end-user device is in communication with the single client instance 102. Also, cloud provider infrastructures may be configured to support any number of client instances, such as client instance 102, concurrently, with each of the instances in communication with one or more end-user devices. As shown, the client device 20 may interact with the client instance 102 by providing inputs 300, to which the client instance 102 may respond with outputs 302.

In the embodiment shown in FIG. 4, the virtual server 26 of the client instance 102 may be used to manage digital signatures for software code executed by the client instance 102, the client device 20, the MID server 24, or any other processor-based device on the client network 12. Code signing is a process of digitally signing software code to establish a root of trust and verify the software code’s authenticity and integrity. When code signing is being used, the signature associated with the software code is verified via a signature verification tool 304 prior to execution of the code.

Software code provided to a customer by a software provider 306 includes cryptographic provider signatures generated by the software provider 306 using a software provider code signing certificate and a private key of a key pair. Upon receipt of the software code, the provider signatures may be stored in a signatures database 308. The customer uses a public key of the key pair to verify the provider signatures via the signature verification tool 304 prior to execution of the software code.

If the customer develops software code in-house, the customer may utilize a signature generation tool 310 to generate cryptographic customer signatures using a customer code signing certificate. Similarly, if the customer makes any customizations to software code received from one or more software providers 306, the customer uses the signature generation tool 310 to generate cryptographic customer signatures for the customized software code using the customer code signing certificate. Prior to execution of the in-house and/or customized software code, the signature verification tool 304 may be used to verify the customer code signing certificate (e.g., using a public key of a public/private key pair).

Some customers may wish to have a customer-revokable root of trust that enables the customer to unilaterally revoke (e.g., without any action taken by the software provider 306) the root of trust and cease execution of all signed software code (e.g., software code from the one or more software providers 306, in-house software code, customized software code, and so forth). However, because the software code provided by the software provider 306 is signed with provider signatures, the root of trust for the software code is controlled by the software provider 306 and thus not unilaterally revokable by the customer. Accordingly, one or more signature generation tools 310, which may run on one of the client instances 102 and/or on customer computing infrastructure 312 (e.g., on-prem servers, cloud servers, remote servers, desktop computers, laptop computers, tablets, mobile devices, edge devices, etc.), may be used to generate customer signatures for the software code provided by the software provider 306 in order to create a unified root of trust for the entirety of the software code (e.g., the software code provided by the software provider and the customizations generated by the customer) that is unilaterally revokable by the customer.

Specifically, the signature generation tool 310, which may run on the primary client instance 102, a different instance 102 (e.g., an instance 102 dedicated to generating signatures), or the customer computing infrastructure 312, uses a customer code signing certificate and a private key of a public/private key pair to generate customer signatures for the software code received from the software provider 306. The customer signatures for the software code received from the software provider 306 supersede the software provider signatures received from the software provider 306. If the customer signatures are generated by the signature generation tool 310 running on the client’s primary instance, the customer signatures are added to the signatures database 308. If the customer signatures are generated by the signature generation tool 310 running on a separate instance 102, the customer signatures may be imported to the primary client instance 102 and added to the signatures database 308. If the customer signatures are generated by the signature generation tool 310 running on the customer computing infrastructure 312, or by some other resource external to the primary client instance 102, the customer signatures may be imported to the customer’s primary client instance 102 and added to the signatures database 308.

After the customer signatures have been added to the signatures database 308, the software provider signatures may be marked as untrusted. For example, the signatures database 308 may be updated such that all software provider signatures stored in the signatures database 308 may be removed or kept in the database, but each marked as untrusted. In other embodiments, a general rule to not trust signatures from one or more of the software providers 306 may be implemented.

Once all of the customer’s software code is associated with customer signatures, the customer has established a unified root of trust for the entirety of its software code, such that the customer can unilaterally revoke the root of trust and prevent execution of code without any action on behalf of one or more of the software providers 306. As such, if a vulnerability, intrusion, or other issue is discovered, the customer may be able to cease execution of code quickly without relying on one or more of the software providers 306 taking any action.

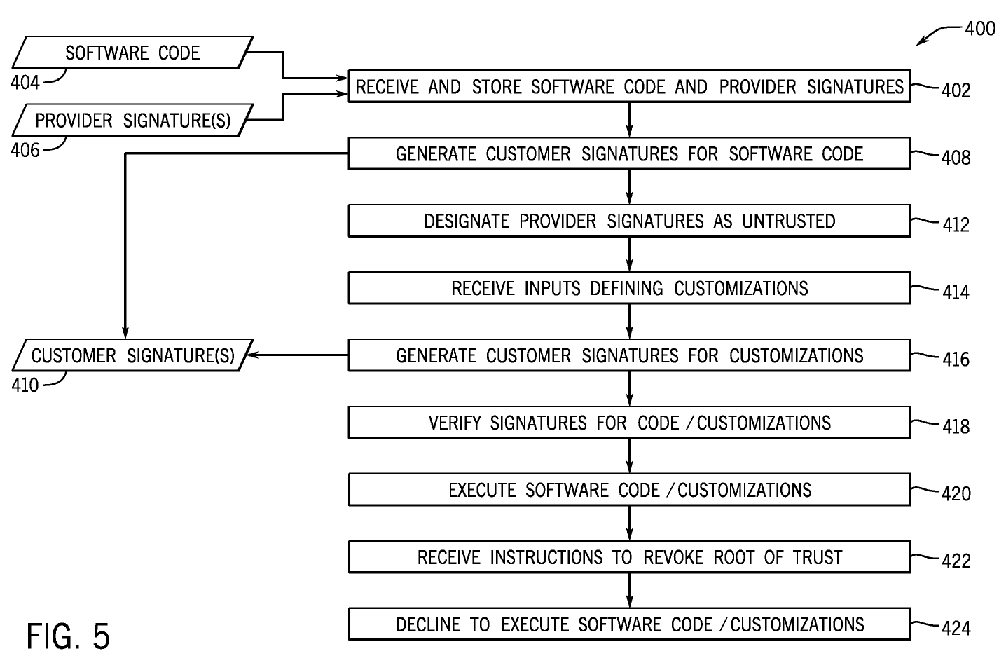

FIG. 5 is a flow chart of a process 400 for creating a unified, unilaterally revokable root of trust for an enterprise’s software code. At 402, the process 400 receives and stores software code 404 and one or more provider signatures 406 from a software provider. The software code 404 may be downloaded from an application store or application repository, downloaded from a code repository, downloaded from a website or elsewhere on the internet, downloaded from the cloud, received directly from the software provider (e.g., via an email, etc.), received via removable memory (e.g., external hard drive, thumb drive, etc.), disk, and so forth. The provider signatures 406 may be embedded in the received code, otherwise accompany the code, or be received separately from the software code 404, in the same way the software code 404 is received or in a different way than the software code 404 was received.

At 408, the process 400 generates one or more customer signatures 410 for the software code 404 that supersede the provider signatures 406. The customer signatures 410 may be generated using a customer signing certificate and a private key from a public/private key pair. The customer submits a certificate signing request that contains a public key from a public/private key pair to a certificate authority, which may be external to the customer (e.g., a service provider) or which may operate within the customer’s network. The certificate authority verifies the identity of the requestor (e.g., the customer), digitally signs the customer signing certificate with the private key of the public/private key pair, and provides the signed customer signing certificate to the customer. The customer may use the customer signing certificate and the private key to generate the customer signatures 410 for the software code 404 that supersede the provider signatures 406 received with the software code 404. Generating the customer signatures 410 may include, for example, running one or more jobs via a computational instance. For example, running one or more jobs may include parsing the software code to identify instantiations of the first signature and generating the second signature to supersede the first signature using the second code signing certificate. In some embodiments, the computational instance may use a key pair to associate the customer signature with the provider signature.

At 412, the process 400 designates the provider signatures 406 as untrusted. In some embodiments, the process 400 may only designate as untrusted the provider signatures 406 associated with a particular piece or pieces of software code 404. In other embodiments, the process 400 may designate as untrusted all of the provider signatures 406 associated with a particular software provider, multiple software providers, or all external software providers. For example, a signatures database or repository may be updated such that all software provider signatures may be removed from the database/repository or kept in the database/repository, but each marked as untrusted. In other embodiments, a general rule to not trust signatures from one or more external software providers may be implemented.

At 414, the process 400 receives inputs defining one or more customizations to the software code 404. For example, an in-house software developer at the customer, an information technology (IT) administrator, a user, a software customization tool, or some other source may provide inputs making one or more modifications of customizations to the software code 404 that customizes the software code 404 to how the customer uses the software code 404 or plans to use the software code 404 in the future. The customizations may include, for example, custom dashboards, algorithms for calculating key performance indicators (KPIs), other customized algorithms, specification of certain customer-specific policies, integrations with other applications and/or software, and so forth.

At 416, the process 400 generates one or more additional customer signatures 410 for the customizations to the software code 404. As with the customer signatures 410 generated at 416, the customer signatures 410 for the customizations may be generated using the customer signing certificate and the private key from the public/private key pair. As previously described, the customer signatures 410 may be added to a signatures database hosted in a cloud instance. If the signatures are generated within the instance that hosts the signatures database, the signatures may merely be added to the signatures database. If the customer signatures 410 are generated by a signature generation tool running on a separate instance, the customer signatures 410 may be imported to the primary client instance and added to the signatures database. If the customer signatures 410 are generated by the signature generation tool running on customer computing infrastructure, the customer signatures 410 may be imported to the customer’s primary client instance and added to the signatures database.

Because the software code 404 and the customizations are all signed with customer signatures 410, the customer has a unified and unilaterally revokable root of trust for all software code and customizations that it may execute. At 418, the process 400 verifies signatures for the software code 404 and/or any customizations prior to execution. For example, the process may utilize a software verification tool and the public key to verify the customer signatures for all pieces of software code 404 and/or customizations to be executed. In some embodiments, the process 400 may verify the customer signatures before each execution of the software code 404 and/or customizations. In other embodiments, the process 400 may verify the customer signatures before a set number (e.g., 5, 10, 20, 25, 50, 100, 200, 500, 100, etc.) of executions of the software code 404 and/or customizations. In other embodiments, the process 400 may verify the customer signatures for the software code 404 and/or executions to be executed for a set period of time (e.g., 15 minutes, 30 minutes, 1 hour, 2 hours, 8 hours, 12 hours, 24 hours, 48 hours, 72 hours, a shift, a week, a month, a quarter, a year, etc.). At 420, the process 400 executes the software code 404 and/or customizations.

At 422, the process 400 receives instructions to revoke the root of trust for the software code and/or the customizations. The instructions may be received from a client device (e.g., based on inputs provided to a graphical user interface of the client device), based on some condition being detected, in response to an event or alarm, in response to a vulnerability being detected, in response to an intrusion being detected, in response to a problem with the software code 404 and/or customizations being recognized, and so forth. The instructions may include instructions to revoke the root of trust for all software code 404 and/or customizations, or instructions to revoke the root of trust for specific software code 404 and/or customizations. Because the customer signatures 410 supersede the provider signatures 406, and because the provider signatures 406 were designated as untrusted at 412, the customer can unilaterally revoke the root of trust without any action from one or more software providers. Accordingly, if a vulnerability or other issue is discovered, the customer may be able to cease execution of code quickly without relying on the software provider taking any action, thus increasing the speed at which the customer can address the vulnerability or issue. As a result, the amount of time that the network may be exposed to the vulnerability may be greatly reduced. At 424, the process 400, in response to the root of trust being revoked, declines to execute the software code 404 and/or the customizations for which the root of trust was revoked.

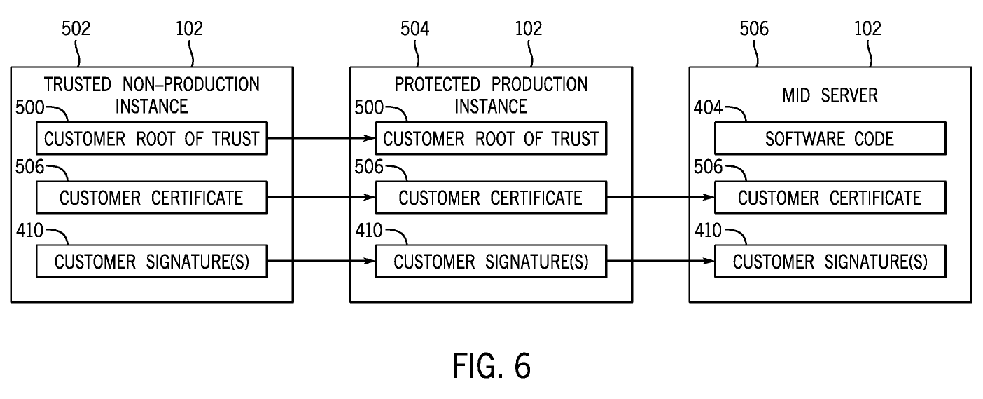

FIG. 6 is a schematic illustrating using two cloud-based computational instances 102 to create a unified, unilaterally revokable customer root of trust 500 for software code 404 executed by a MID server 24. As shown, a customer root of trust 500 is generated and imported into a trusted non-production instance 502. The trusted non-production instance 502 is a cloud-based computational instance 102 used for development, testing, or staging purposes. Data stored on the trusted non-production instance 502 and operations performed by the trusted non-production instance 502 are considered reliable and secure enough to mimic a production instance even though the trusted non-production instance 502 is not directly accessible to some users, allowing for thorough testing without risking real production data. Trusted non-production instances 502 can be used to experiment with new features, validate changes, and identify potential issues before deploying features to production instances (e.g., the protected production instance 504). To ensure accurate testing, the trusted non-production instance 502 is often configured to closely resemble the production instance (e.g., the protected production instance 504) in terms of architecture, data structure, and security settings.

To generate the customer root of trust 500, a circle of trust is established. A circle of trust is a collection of instances, applications, hardware, and/or services capable of mutually verify each other's identities and authenticity by sharing digital certificates. Accordingly, once a circle of trust is established, the result is a trusted network in which authorized entities can access sensitive data, where each participant within the circle holds a unique private key and a corresponding public key that can be shared with other participants to verify their identity.

After the circle of trust has been established, a signing key pair (e.g., a public/private key pair) is generated. The signing key pair may be generated within the trusted non-production instance 502, or by some external resource. The signing key pair is different from the key pair(s) used to establish the circle of trust. The signing key pair is used to generate a customer root of trust 500 based on a customer certificate 506. As previously described, the customer certificate is used to generate customer signatures 410. As described above, the customer certificate 506 may be generated by a certificate authority in response to a certificate signing request.

The customer root of trust 500 and the customer certificate 506 are transferred from the trusted non-production instance 502 to the protected production instance 504. The customer certificate 506 is installed on the MID server’s 24 trust store. The customer signatures 410 are also imported to the protected production instance 504. The customer root of trust 500 is then installed on the MID server 24 and enabled. Once the customer root of trust 500 is enabled, all software code 404 must be signed using the customer signatures 410 before the MID server 24 can execute the software code 404. Accordingly, the MID server 24 is rebooted, which causes the MID server 24 to download the customer certificate 506 from the protected production instance 504. Thereafter, the MID server 24 will only be able to execute code verified by the customer root of trust 500.

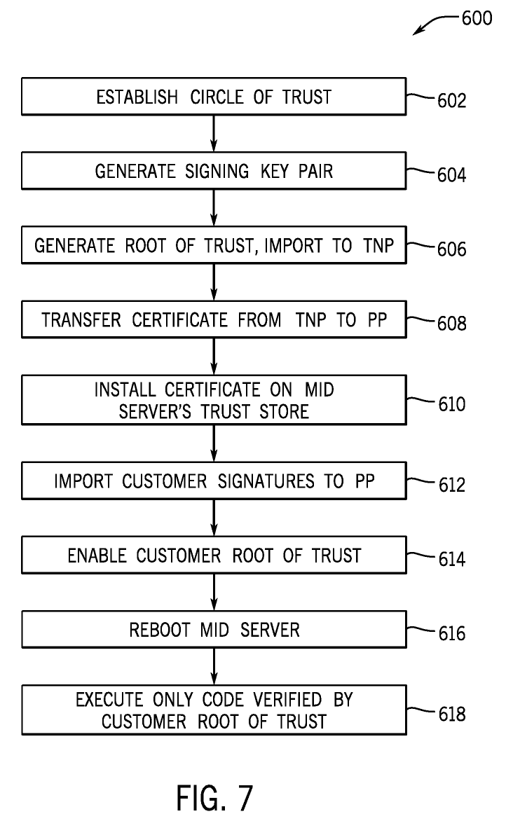

FIG. 7 is a flow chart of a process 600 for using two cloud-based computational instances to create a unified, unilaterally revokable customer root of trust for software code executed by a MID server. At 602, the process 600 establishes a circle of trust. As previously described, a circle of trust is a collection of instances, applications, hardware, and/or services capable of mutually verify each other's identities and authenticity by sharing digital certificates. Accordingly, to establish the circle of trust, a trusted non-production instance (e.g., an instance that is used for development, testing, and/or staging) may exchange digital certificates and/or public/private key pairs with a protected production instance, a MID server, a signing authority, and/or any other entities that may be included in the circle of trust.

At 604, the process 600 generates a signing key pair that includes a public key and a private key. The signing key pair is different from the key pair(s) used to establish the circle of trust. The signing key pair may be generated within the trusted non-production instance, or by some external resource.

At 606, the process 600 generates a root of trust and imports the root of trust into the trusted non-production instance. The root of trust may be generated using the signing key pair based on the customer certificate (e.g., generated by a certificate authority in response to a signing request). If the root of trust is generated external to the trusted non-production instance, the root of trust may be imported to the trusted non-production instance.

At 608, the process 600 transfers the customer root of trust, the customer certificate from the trusted non-production instance to the protected production instance. At 610, the process 600 installs the certificate on the MID server’s trust store. At 612, the process 600 imports the customer signatures to the protected production instance. At 614, the process 600 enables the customer root of trust, after which all software code must be signed using the customer signatures before the MID server can execute the software code.

At 616, the MID server is rebooted. During reboot, the process 600 downloads the customer certificate from the protected production instance to the MID server and the customer root of trust is installed on the MID server. At 618, the process 600 only allows the MID server to execute code verified by the customer root of trust (e.g., code singed by a verified customer signature). For example, the process 600 may utilize a software verification tool and the public key to verify the customer signatures for all pieces of software code and/or customizations prior to execution.

The presently disclosed techniques are directed to generating a customer-revokable root of trust for software code. A customer receives software code from a software provider that is signed with a signature generated by the software provider using a software provider code signing certificate. Specifically, the software provider uses the software provider code signing certificate and a signing tool to create a cryptographic signature for the software code using the software provider’s private key. The customer uses a public key to verify the signature prior to execution of the software code. If the customer makes any customizations to the software code, the customer uses a customer signing certificate to generate a customer signature for the customizations. To unify the root of trust for the entirety of the software code (e.g., the software code provided by the software provider and the customizations generated by the customer), the customer uses the customer signing certificate to generate new customer signatures for the software code provided by the software provider that supersede the provider signatures generated by the software provider. In some embodiments, the customer may use a customer instance to generate the new signatures, which may include an instance dedicated to generating signatures, or the customer’s primary instance. In other embodiments, the customer may use a signature generation tool running on the customer infrastructure (e.g., “on prem”) to generate signatures and import the signatures to the customer’s instance. The customer then designates the signatures from the software provider as untrusted. With a unified root of trust for the entirety of the software code, the customer may unilaterally revoke the root of trust based on the customer signing certificate at will to prevent execution of signed code. Accordingly, use of the disclosed techniques enables the customer to unilaterally prevent execution of code without any action on behalf of the software provider. As such, if a vulnerability or other issue is discovered, the customer may be able to cease execution of code quickly without relying on the software provider taking any action, increasing the speed at which the customer can address the vulnerability or issue and reducing the amount of time that the network may be exposed to the vulnerability.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
accessing software code, wherein the software code is signed with a first signature based on a first code signing certificate;
generating a second signature for the software code using a second code signing certificate, wherein the second signature for the software code supersedes the first signature; and
in response to verifying the second signature, executing the software code.

2. The method of claim 1, wherein:
the first signature comprises a software provider signature;
the first code signing certificate comprises a software provider code signing certificate;
the second signature comprises a customer signature; and
the second code signing certificate comprises a customer code signing certificate.

3. The method of claim 1, wherein generating the second signature for the software code using the second code signing certificate comprises running one or more jobs via a computational instance.

4. The method of claim 3, wherein running the one or more jobs via the computational instance comprises:
parsing the software code to identify the first signature; and
in response to identifying the first signature, generating the second signature to supersede the first signature using the second code signing certificate.

5. The method of claim 3, wherein running the one or more jobs via the computational instance comprises using a key pair to associate the second signature with the first signature.

6. The method of claim 1, wherein generating the second signature for the software code is via a first computational instance and wherein executing the software code is via a second computational instance.

7. The method of claim 1, wherein generating the second signature for the software code using the second code signing certificate comprises generating the second signature via an external signature tool and importing the second signature into a computational instance.

8. The method of claim 1, comprising:
receiving, from a client device, one or more customizations to the software code;
generating a third signature for the customized software code using the second code signing certificate; and
in response to verifying the third signature, executing the customized software code.

9. The method of claim 1, comprising:
receiving, from a client device, instructions to revoke a root of trust;
revoking the root of trust by designating the second signature as invalid; and
in response to a failing to verify the second signature, declining to execute the software code.

10. The method of claim 1, wherein the software code is configured to be executed by a MID server.

11. The method of claim 1, comprising designating the first signature as untrusted after generating the second signature.

12. A system, comprising:
processing circuitry; and
a memory, accessible by the processing circuitry, and storing instructions that, when executed by the processing circuitry, cause the processing circuitry to execute a client instance, wherein the client instance is configured to perform operations comprising:
accessing software code, wherein the software code is signed with a first signature based on a first code signing certificate;
generating a second signature for the software code using a second code signing certificate, wherein the second signature for the software code supersedes the first signature; and
in response to verifying the second signature, executing the software code.

13. The system of claim 12, wherein:
the first signature comprises a software provider signature;
the first code signing certificate comprises a software provider code signing certificate;
the second signature comprises a customer signature; and
the second code signing certificate comprises a customer code signing certificate.

14. The system of claim 12, wherein the operations comprise:
receiving, from a client device, instructions to revoke a root of trust;
revoking the root of trust by designating the second signature as invalid; and
in response to a failing to verify the second signature, declining to execute the software code.

15. The system of claim 12, wherein the software code is configured to be executed by a MID server.

16. A non-transitory, computer readable medium comprising instructions that, when executed by processing circuitry, cause the processing circuitry to perform operations comprising:
accessing software code, wherein the software code is signed with a first signature based on a first code signing certificate;
generating a second signature for the software code using a second code signing certificate, wherein the second signature for the software code supersedes the first signature; and
in response to verifying the second signature, executing the software code.

17. The computer readable medium of claim 16, wherein:
the first signature comprises a software provider signature;
the first code signing certificate comprises a software provider code signing certificate;
the second signature comprises a customer signature; and
the second code signing certificate comprises a customer code signing certificate.

18. The computer readable medium of claim 16, wherein generating the second signature for the software code using the second code signing certificate comprises running one or more jobs via a computational instance by:
parsing the software code to identify the first signature; and
in response to identifying the first signature, generating the second signature to supersede the first signature using the second code signing certificate.

19. The computer readable medium of claim 16, wherein generating the second signature for the software code is via a first computational instance, wherein executing the software code is via a second computational instance.

20. The computer readable medium of claim 16, wherein generating the second signature for the software code using the second code signing certificate comprises generating the second signature via an external signature tool and importing the second signature into a computational instance.
